(19) United States
(12) Patent Application Publication
(10) Pub. No.: US 2017/0336932 A1
(43) Pub. Date: Nov. 23, 2017

(54) IMAGE DISPLAY APPARATUS ALLOWING OPERATION OF IMAGE SCREEN AND OPERATION METHOD THEREOF

(71) Applicant: Sharp Kabushiki Kaisha, Osaka (JP)

(72) Inventors: Masafumi OKIGAMI, Sakai City (JP); Satoshi TERADA, Sakai City (JP)

(21) Appl. No.: 15/673,446

(22) Filed: Aug. 10, 2017

Related U.S. Application Data
(63) Continuation of application No. 14/306,404, filed on Jun. 17, 2014.

(30) Foreign Application Priority Data
Jun. 21, 2013 (JP) 2013-130701

(51) Int. Cl. G06F 3/0483; G06F 3/0488

(52) U.S. Cl. CPC G06F 3/0483; G06F 3/04883

(57) ABSTRACT

An image display apparatus includes a display unit for displaying an image, a detecting unit for detecting a position designated by an operation of designating a position on the displayed image and a file operation unit operating a file. The display unit displays images generated from a file on page-by-page basis on a partial area of the display unit. The file operating unit operates the file in accordance with the change of position detected by the detecting unit, when, in a state in which no position has been detected by the detecting unit, a designated position outside of the prescribed partial area is first detected by the detecting unit and the designated position changes while the position designating operation is maintained and then no position is detected by the detecting unit. Thus, the user can easily and intuitively operate the displayed page image or the file.

### CROSS-REFERENCE TO RELATED APPLICATIONS

This nonprovisional application claims priority under 35 U.S.C. §119(a) on Patent Application No. 2013-130701 filed in Japan on Jun. 21, 2013, the entire contents of which are hereby incorporated by reference.

### BACKGROUND OF THE INVENTION

### Field of the Invention

The present invention relates to an image display apparatus allowing operation of image screen that allows easy and intuitive operation of a page image displayed on a partial area of a display screen or operation of its file, as well as to a method of operating the same.

### Description of the Background Art

In an image display apparatus such as an liquid crystal display, as a user interface for operating a window displayed on the display screen, a method of clicking buttons and icons displayed on the window or selecting from a pull-down menu to realize a prescribed process has been known. A mouse for a computer has been conventionally known as an operating device for this purpose. Recently, a display apparatus provided with a device allowing touch operation such as a touch-panel (hereinafter referred to as a touch-panel display) has come to be popularly used. It provides an environment allowing an intuitive operation of a user, in which the user touches the display screen and operates an object. In accordance with this trend, improvement in touch operation characteristic has been desired.

By way of example, Japanese Patent Laying-Open No. 2012-155491 (hereinafter referred to as '491 Reference) discloses an input apparatus which can prevent erroneous input of operation keys on the touch-panel, in order to improve operation characteristic of the touch-panel. Specifically, regarding a flick operation (an operation of quickly moving one's finger or the like touching the touch-panel to a prescribed direction and thereafter moving the finger or the like away from the touch-panel) on a touch-panel display on which a plurality of operation keys are displayed, two adjacent keys are set to have mutually different flick directions (directions to receive the flick operation). When an operator flicks, the operated operation key is specified based on the area on which the touch has been ended, as well as on the flick direction. Thus, it becomes possible to prevent with high accuracy erroneous input of operation keys on the touch-panel on which operation keys are displayed adjacent to each other.

The operation characteristic of a display screen, however, is not sufficiently improved. Recently, a touch-panel display of large size come to be practically used and the amount of information that can be displayed at one time is increasing. Therefore, while such a display becomes more convenient, objects to be operated increases. Therefore, still more improvement in operability is desired to effectively utilize the increasing amount of information.

Referring to FIG. 1, a problem of touch operation on the touch-panel display will be specifically described. FIG. 1 shows a state in which an image of a file is displayed on a page-by-page basis, on one window 902 displayed on a display screen 900 of a touch-panel display. The image displayed on the page-by-page basis is referred to as a “page image.”

A button 904 on an upper right corner is for switching a mode of touch operation. Specifically, when button 904 is touched, operation enters enters a drawing mode (when selected, the button is high-lighted). In the drawing mode, the user can draw a line by touching the touch-panel arranged on display screen 900. Specifically, when the user moves the touching position while keeping contact with the screen, a line is displayed along the trajectory of touching, on display screen 900.

In a state not set in the drawing mode, it is possible to operate window 902 by a touch operation. For example, by a flick operation or a swipe operation (an operation of sliding a finger or the like touching the image screen in one direction) in the right/left direction, a next page or previous page of the currently displayed page can be displayed. By touching and dragging a frame (edge) of a window, it is possible to change the position of displaying the window on the display screen 900. In FIG. 1, the swipe operation to the left by a user 906 is represented by a left arrow. The user's hand at the initially touched position is shown in dotted lines. By the swipe operation, the next page image, for example, is displayed on window 902.

While the touch-panel display as such is set in the drawing mode and the user performs a window operation (for example, when he/she swipes to the left to see a different page), the window operation does not take place but a line is drawn along the trajectory of touching. By way of example, FIG. 1 shows a state in which a line 908 is drawn by the swipe operation to the left. Here, the user must first perform an operation of erasing the drawn line 908 (for example, if an eraser function is allocated to any of the buttons at the upper right corner, the user operates that button), cancel the drawing mode by touching button 904, and then, perform the same window operation (swipe to the left). Such operations are very troublesome for the user.

In order to avoid such a situation, it is necessary for the user to be always aware of whether the display is in the drawing mode, or to confirm the mode before starting any operation, which is rather burdensome for the user. Particularly when a large touch-panel display displaying an image is shared among a plurality of users discussing while operating the image screen, we cannot expect that every user correctly recognizes whether the operation is in the drawing mode or not and operates the image screen appropriately. Further, it is troublesome to cancel and reset the drawing mode when only one window operation is to be done.

This problem is not limited to drawing along the trajectory of touching. An image display apparatus having a function of drawing a pre-set figure or the like at a touched position has been known, and the same problem occurs in such an apparatus.

The technique disclosed in '491 Reference does not suppose an operation on a touch-panel display of a large size, and the problem described above that occurs when the window is operated on the large-size touch-panel display cannot be solved.

### SUMMARY OF THE INVENTION

In view of the foregoing, it is desirable to provide an image display apparatus allowing operation of a screen image that allows easy and intuitive operation of a page image displayed on a partial area of a display screen or operation of its file, as well as to a method of operating the same.

The present invention provides an image display apparatus, including: a display unit displaying an image; a detecting unit detecting a position designated by an operation of designating a position on the image displayed by the display unit; and a file operation unit operating a file. The display unit displays an image generated from data contained in one file page by page on a prescribed partial area of the display unit. The file operation unit operates the file in accordance with the change of position detected by the detecting unit, when, in a state in which no position has been detected by the detecting unit, a designated position outside of the prescribed partial area is first detected by the detecting unit and the designated position changes while the position designating operation is maintained and then no position is detected by the detecting unit.

Preferably, the image display apparatus further includes a determining unit for determining, when the designated position outside of the prescribed partial area is first detected by the detecting unit in the state in which no position has been detected by the detecting unit, whether the designated position has come to be within the prescribed partial area, after the designated position changes while the position designating operation is maintained. If it is determined by the determining unit that the designated position has come to be within the prescribed partial area, the file operating unit operates the file in accordance with a positional relation between a trajectory formed by the change of position detected by the detecting unit and the prescribed partial area.

More preferably, the prescribed partial area is a rectangle; and information indicating the file operation is displayed in an area outside the prescribed partial area along at least one side of the rectangle.

More preferably, the detecting unit includes a touch-detecting unit arranged on a display area of the display unit displaying an image, for detecting a touched position; and the operation of designating the position on the image displayed by the display unit is a touch operation.

Preferably, the prescribed partial area is a rectangle; and the file operation by the file operating unit differs depending on which one of the four sides of the rectangle intersects with a trajectory formed by the change of position detected by the detecting unit.

More preferably, the file includes information related to an order of displaying the image displayed page by page; and the file operation by the file operating unit when the direction of the change of position detected by the detecting unit while the image is displayed page by page on the prescribed partial area is a right/left direction is an operation to change the image displayed page by page in accordance with the order of displaying.

More preferably, the file includes information related to an order of displaying the image displayed page by page; and the file operation by the file operating unit, when the direction of the change of position detected by the detecting unit while the image is displayed page by page on the prescribed partial area is an upward/downward direction, is an operation of stopping displaying the image generated from the data contained in the file page by page, or an operation of printing the image generated from the data contained in the file page by page.

According to another aspect, the present invention provides a method of operating an image display apparatus, including the steps of displaying an image on an entire surface of a display screen of an image display apparatus; displaying an image generated from data contained in one file page by page on a prescribed partial area on the display screen; detecting a position designated by an operation of designating a position on the image displayed on the entire surface of the display screen; and operating the file in accordance with the change of position detected at the detecting step, when, in a state in which no position has been detected at the detecting step, a designated position outside of the prescribed partial area is first detected at the detecting step and the designated position changes while the position designating operation is maintained and then no position is detected.

By the present invention, the operation of a file displayed as a page image on the display screen can be easier and more intuitive than ever before. By way of example, it is possible for the user to operate a file displayed as a page image as if he/she turns pages of paper. Further, it is possible for the user to close a displayed file or to print a displayed page image in much easier manner than before.

Particularly, operation characteristic when a user giving an explanation while operating a file and a user or users as the audience share one display simultaneously, for example, at a meeting, can be improved. For instance, a time-taking procedure of the explaining user of once opening the file to display a window and clicking a button in the window anew to perform an intended operation, or display of unnecessary information for the audience such as a pull-down menu necessary for the operation can be avoided. Thus, the user can be freed from the irritations, and better user experience related to the operation can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a conventional operation of an image screen.

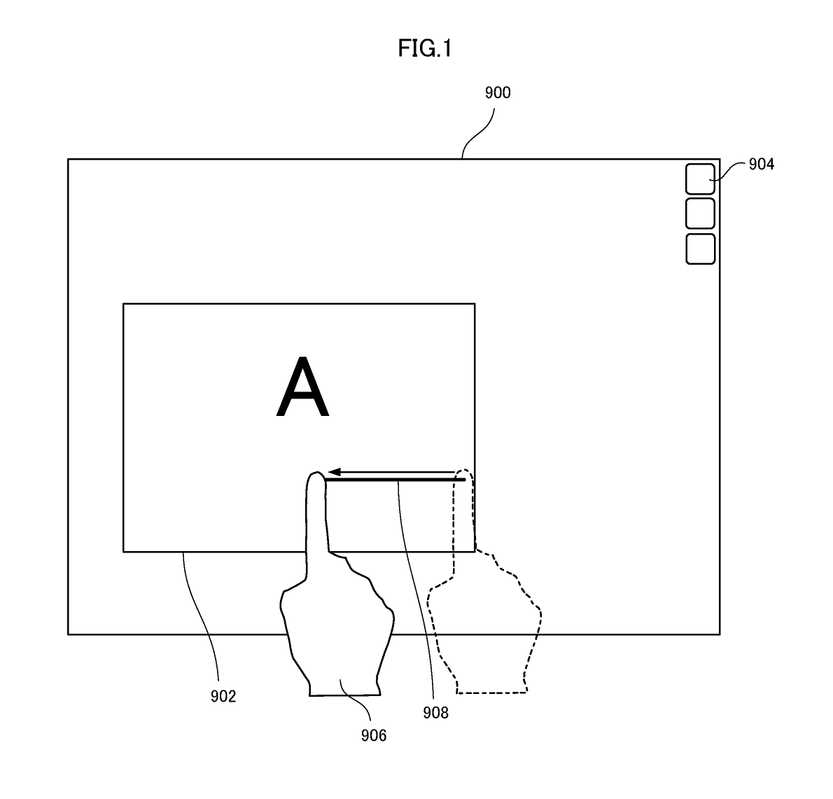

FIG. 2 shows a schematic configuration of an image display apparatus in accordance with an embodiment of the present invention.

FIG. 3 shows an example of a method of detecting a touch input.

FIG. 4 shows an example of a display screen of the image display apparatus shown in FIG. 2.

FIG. 5 is a flowchart representing a control structure of a program realizing the operation of a file displayed in a window of the image display apparatus shown in FIG. 2.

FIG. 6 shows an operation of a file displayed in a window of the image display apparatus shown in FIG. 2.

FIG. 7 shows an operation method different from that of FIG. 6.

FIG. 8 shows an operation method different from those of FIGS. 6 and 7.

FIG. 9 shows an operation method different from those of FIGS. 6 to 8.

### DESCRIPTION OF THE PREFERRED EMBODIMENTS

In the embodiment below, the same components are denoted by the same reference characters. Their names and functions are also the same. Therefore, detailed description thereof will not be repeated.

In the following, “touch” means a state in which a detecting device for detecting an input position can detect the position, and it includes a state (in which one's finger or the like is) in contact with and pressing the detecting device, a state in contact with but not pressing the detecting device, and a state not in contact but in the vicinity of the detecting device. As will be described later, as the detecting device for detecting an input position, a contact type as well as non-contact type device may be used. When a non-contact type detecting device is used, “touch” means that one's finger or the like comes to a distance to the detecting device close enough for the device to detect the input position.

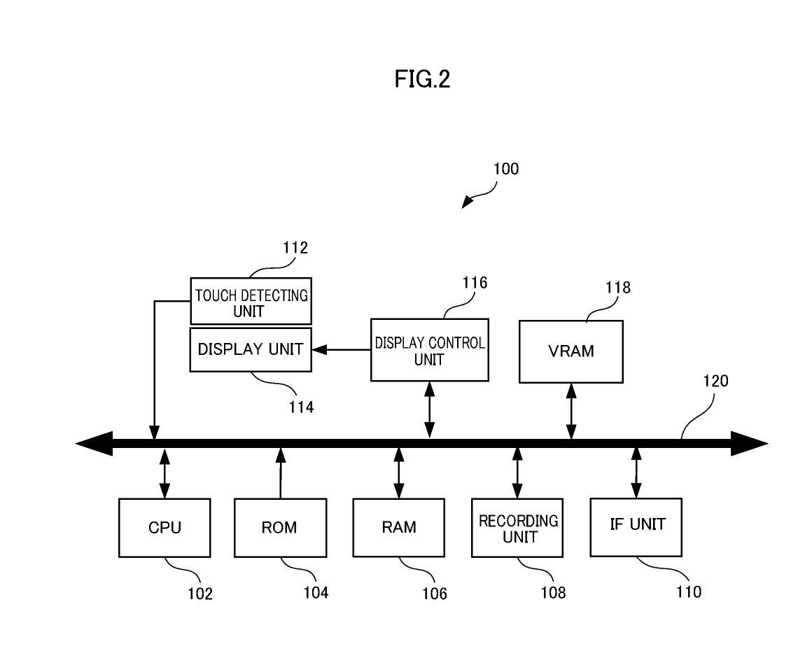

Referring to FIG. 2, an image display apparatus 100 in accordance with an embodiment of the present invention includes a computing unit (hereinafter referred to as CPU) 102, a read only memory (hereinafter referred to as ROM) 104, a rewritable memory (hereinafter referred to as RAM) 106, a recording unit 108, an interface unit (hereinafter denoted as IF unit) 110, a touch-detecting unit 112, a display unit 114, a display control unit 116, a video memory (hereinafter referred to as VRAM) 118 and a bus 120. CPU 102 is for overall control of image display apparatus 100.

ROM 104 is a non-volatile storage device, storing programs and data necessary for controlling operations of image display apparatus 100. RAM 106 is a volatile storage device of which data is erased when power is turned off. Recording unit 108 is a non-volatile storage device retaining data even when the power is turned off, such as a hard disk drive or a flash memory. Recording unit 108 may be configured to be detachable. CPU 102 reads a program from ROM 104 to RAM 106 through bus 120 and executes the program using a part of RAM 106 as a work area. CPU 102 controls various units and parts forming image display apparatus 100 in accordance with a program stored in ROM 104.

CPU 102, ROM 104, RAM 106, recording unit 108, touch-detecting unit 112, display control unit 116 and VRAM 118 are connected to bus 120. Data (including control information) is exchanged between each of these units through bus 120.

Display unit 114 is a display panel (such as a liquid display panel) for displaying an image. Display control unit 116 includes a drive unit for driving display unit 114. Display control unit 116 reads image data stored in VRAM 118 at a prescribed timing, generates and outputs to display unit 114 a signal for displaying it as an image on display unit 114. The displayed image data is read by CPU 102 from recording unit 108 and transmitted to VRAM 118.

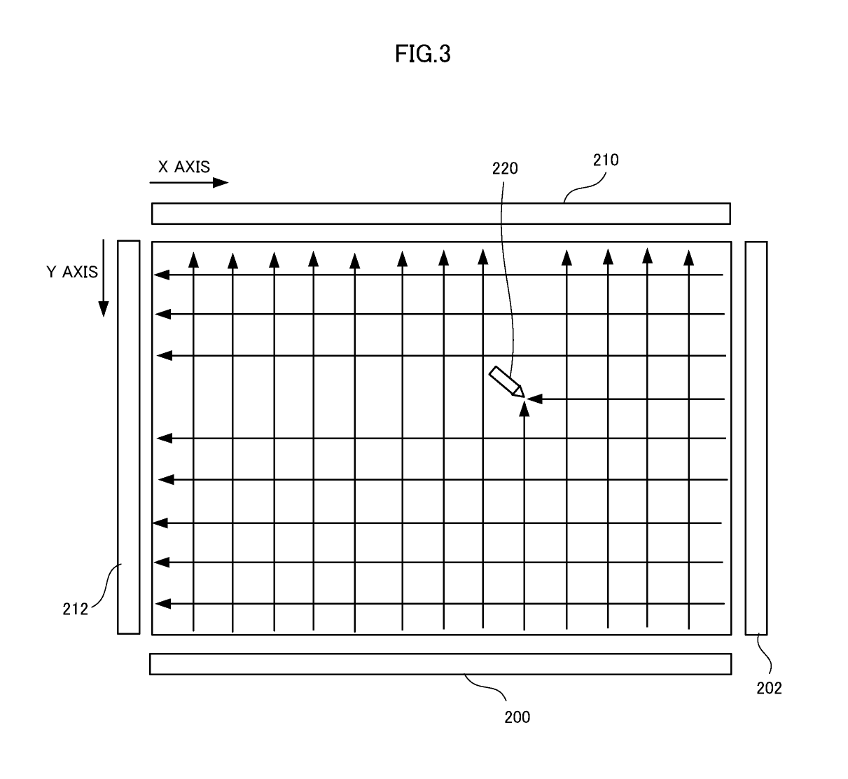

Touch-detecting unit 112 is, for example, a touch-panel, which detects a touch operation by the user. Touch-detecting unit 112 is arranged superposed on the display screen of display unit 114. Therefore, a touch on touch-detecting unit 112 is an operation of designating a point on the image displayed on the display screen corresponding to the touched position. The detection of touch operation when a touch-panel is used as touch-detecting unit 112 will be described later with reference to FIG. 3.

IF unit 110 connects image display apparatus 100 to an external environment such as a network. IF unit 110 is, for example, an NIC (Network Interface Card), and it transmits/receives image data to/from a computer or the like connected to the network. Image data received from the outside through IF unit 110 is recorded in recording unit 108. Further, a print instruction to an image forming apparatus such as a printer connected to the network is given through IF unit 110.

Image display apparatus 100 shown in FIG. 2 is not limited to one having the components all arranged close to each other and formed as one integrated body. By way of example, though touch-detecting unit 112 and display unit 114 are arranged as an integrated body, other components may be arranged apart from touch-detecting unit 112 and display unit 114. For instance, components other than touch-detecting unit 112 and display unit 114 may be a general purpose computer capable of outputting a prescribed video signal. In such a case, the video signal output from the general purpose computer may be transferred through a cable or radio wave to display unit 114, and an output signal from touch-detecting unit 112 may be transferred through a cable or radio wave to the general purpose computer.

FIG. 3 shows an infrared scanning type touch-panel (touch-detecting unit 112). The touch-panel has arrays of light emitting diodes (hereinafter denoted as LED arrays) 200 and 202 arranged in a line on adjacent two sides of a rectangular writing surface, respectively, and two arrays of photodiodes (hereinafter referred to as PD arrays) 210 and 212 arranged in a line opposite to LED arrays 200 and 202, respectively. Infrared rays are emitted from each LED of LED arrays 200 and 202, and the infrared rays are detected by each PD of opposite PD arrays 210 and 212. In FIG. 3, infrared rays output from LEDs of LED arrays 200 and 202 are represented by upward and leftward arrows.

The touch-panel includes, for example, a micro computer (a device including a CPU, a memory, an input/output circuit and the like), and controls emission of each LED. Each PD outputs a voltage corresponding to the intensity of received light. The output voltage from the PD is amplified by an amplifier. Since signals are output simultaneously from the plurality of PDs of PD arrays 210 and 212, the output signals are once saved in a buffer and then output as serial signals in accordance with the order of arrangement of PDs, and transmitted to the micro computer. The order of serial signals output from PD array 210 represents the X coordinate. The order of serial signals output from PD array 212 represents the Y coordinate.

When a user touches a point on the touch-panel with a touch pen 220, the infrared ray is intercepted by the tip of touch pen 220. Therefore, the output voltage of PD that has been receiving the infrared ray before the interception drops. Since the signal portion from the PD that corresponds to the touched position (XY coordinates) decreases, the micro computer detects a portion where the signal levels of received two serial signals decreased, and thereby finds the position coordinates of the touched position. The micro computer transmits the determined position coordinates to CPU 102. The process for detecting the touched position is repeated periodically at prescribed detection interval and, therefore, if one point is kept touched for a time period longer than the detection interval, it follows that the same coordinate data is output repeatedly. If any point on the touch-panel is not touched, the micro computer does not transmit any position coordinates. The touched position can be detected in the similar manner when the user touches touch-detecting unit 112 with his/her finger without using touch pen 220.

The technique for detecting the touched position described above is well known and, therefore, further description will not be given here. A touch-panel other than the infrared scanning type panel (such as a capacitive type, surface acoustic wave type or resistive type touch-panel) may be used as touch-detecting unit 112. When a capacitive touch-panel is used, a position can be detected even when a finger or the like is not actually touching (non-contact), if it is close enough to the sensor.

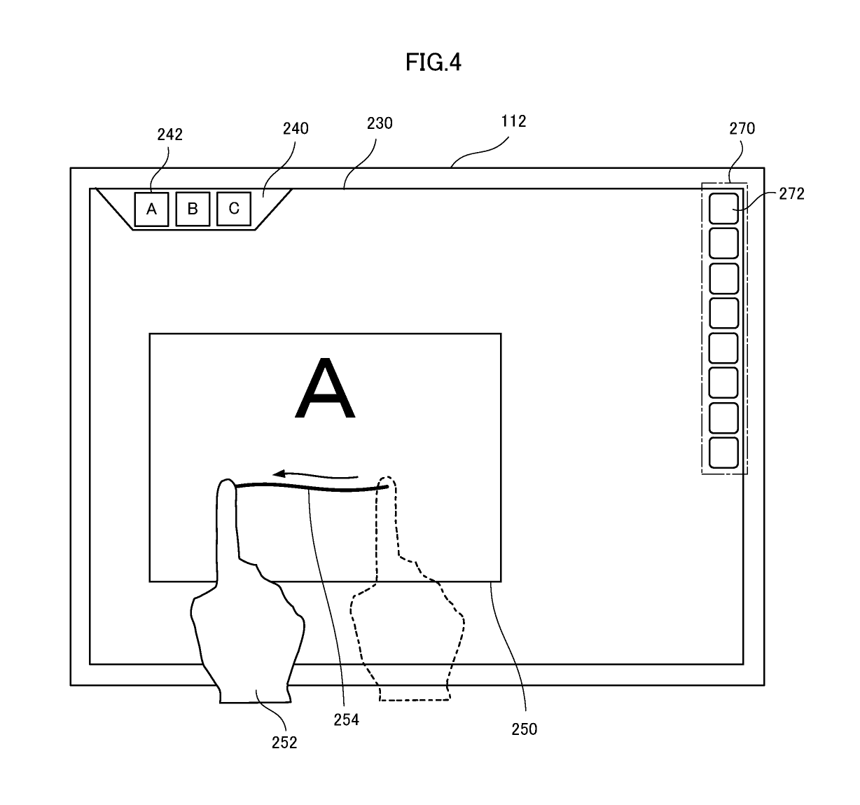

FIG. 4 shows a state in which an image is displayed on the display screen of display unit 114. Such a display is realized when a prescribed program stored in ROM 104 is executed by CPU 102.

A tray 240 is displayed at an upper left corner of display screen 230, and in the area, icons 242 representing files are displayed. In FIG. 4, three icons A to C are displayed. The files represented by respective icons are stored, for example, in recording unit 108. Here, it is assumed that each file contains a plurality of page images. This means that each file contains data that can be represented as a plurality of page images. Here, it is assumed that the user touches touch-detecting unit 112 with his/her finger. The user may touch not with his/her finger (for example, with a pen). A touch operation of touching a portion of touch-detecting unit 112 positioned on an image (such as an icon) displayed on display unit 114 will be described as a touch operation to an image displayed on display unit 114.

When each icon is double-tapped by a finger (substantially the same position of touch-detecting unit 112 is touched twice consecutively), or drag-and-dropped to the outside of tray 240 (the position of touch-detecting unit 112 on an icon is touched and moved while kept touched, and then the finger is left from touch-detecting unit 112), for example, the data of corresponding file is displayed as a page image of a prescribed size on display screen 230. In the following, the area displayed as the page image will be referred to as a window, and an operation to the icon will be referred to as an icon operation. An icon operation of generating a page image from file data and displaying the same will be referred to as a “file open” operation.

In FIG. 4, by an operation to icon 242, the corresponding file is opened and a page image is displayed in a window 250 on display screen 230. Here, which of the images in the file is displayed first is not specifically limited. By way of example, an image of the first page (page 1) of a prescribed order set in advance is displayed.

On a function button area 270 at an upper right corner of display screen 230, a plurality of buttons for instructing execution of various functions of image display apparatus 100 are displayed. To each function button, a specific function is allocated. It is assumed that the function allocated to function button 272 is a function of setting and cancelling the drawing mode by a touch operation (set and cancel are switched every time the button is touched, and in the set state, the function button is high-lighted). Functions allocated to function buttons other than function button 272 include a function of displaying files saved in recording unit 108 as icons in tray 240, a function of stopping image display (erasing a window) of a file (file close), a function of saving a displayed page image in recording unit 108, a function of printing a file of which image is being displayed, a function of setting types of lines (color, thickness and the like) drawn in the drawing mode, and the like.

When the drawing mode is set, as in the conventional example, a line is drawn along the trajectory of touching by the user. FIG. 4 shows a state in which a user 252 touches a touch-detecting unit 112 with his/her index finger and moves the finger to the left as indicted by the arrow while it is kept in the touched state, so that a line 254 is drawn. The user's hand at the initially touched position is shown in dotted lines. When the drawing mode is cancelled, a window operation can be done as in the conventional example.

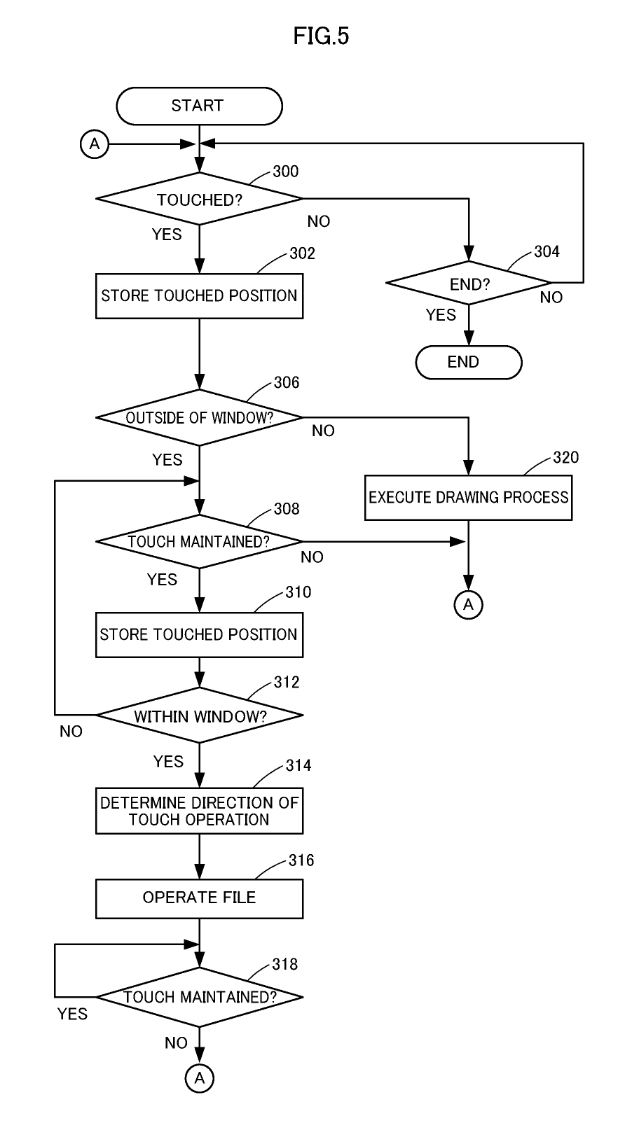

An operation of the file of which window is displayed on image display apparatus 100 will be described in the following with reference to FIG. 5. In the following description, it is assumed that on the screen image shown in FIG. 4, function button 272 of drawing is selected and hence image display apparatus 100 is in the drawing mode.

At step 300, CPU 102 determines whether or not touch-detecting unit 112 is touched. As described above, CPU 102 determines whether or not coordinate data is received from touch-detecting unit 112. When not touched, touch-detecting unit 112 does not output any position coordinates, and when touched, it outputs position coordinates (X coordinate, Y coordinate) of the touched point. If it is determined that it is touched, the control proceeds to step 302. Otherwise, the control proceeds to step 304.

At step 302, CPU 102 stores the received coordinate data (touch start position) in RAM 106.

At step 304, CPU 102 determines whether or not the program is to be terminated. CPU 102 ends the program if an end button, allocated to one of the function buttons, is pressed. Otherwise, the control returns to step 300 to wait for a touch.

At step 306, CPU 300 determines whether or not the position touched at step 300 is outside a window 250. Here, window 250 is a page image generated from the data of designated file and displayed on display screen 230 by CPU 102 in accordance with an icon operation by the user. CPU 102 has the position information of window 250 stored, for example, in RAM 106 and manages the information so that the manner of displaying window 250 can be changed in accordance with an operation on the window (by way of example, position coordinates of upper left and lower right corners of window 250 are stored). Thus, CPU 102 determines whether or not the coordinates stored at step 302 are positioned outside the rectangular area specified by the position information of window 250. If it is determined to be positioned outside of window 250, the control proceeds to step 308. Otherwise (if it is positioned inside window 250), the control proceeds to step 320.

At step 320, CPU 102 executes the drawing process in the similar manner as in the conventional example. Specifically, when it is determined that the touched position has been changed while the touched state is maintained, a line along the trajectory of touched positions (the line connecting received position coordinates in the order of reception) is displayed on window 250. Thereafter, when touching is stopped (when position coordinates are no longer received by CPU 102), the control returns to step 300.

At step 308, CPU 102 determines whether touching is maintained. Specifically, CPU 102 determines whether or not position coordinates are continuously received. By way of example, a time period little longer than the detection period of touch-detecting unit 112 is set as a prescribed time period, and if position coordinates are received within the prescribed time period, CPU 102 determines that touching is maintained, and the control proceeds to step 310. If position coordinates are not received within the prescribed time period, CPU 102 determines that the touching is not maintained (the user's finger is moved away from touch-detecting unit 112), and the control returns to step 300.

At step 310, CPU 102 stores the position coordinates received at step 308 in RAM 106. As will be described later, step 310 is executed repeatedly. Therefore, a prescribed number of received position coordinates are stored in such a manner that the order of reception is made clear. If the number of received position coordinates exceeds the prescribed number, the oldest (earliest received) of the stored position coordinates is overwritten by the latest position coordinates. Thus, it follows that the prescribed number of position coordinates from the latest ones are kept stored.

At step 312, CPU 102 determines whether or not the touched position is in window 250. Specifically, CPU 102 determines whether the latest position coordinates received at step 308 represent a position within the rectangular area specified by the position information of window 250. If it is determined that the touched position is within the window 250, the control proceeds to step 314. Otherwise (if it is outside window 250), the control returns to step 308.

In this manner, through steps 300 to 312, it is possible to detect that a point in the area outside of window 250 was touched first, and the touched position was moved to the inside of window 250 while touching was maintained.

At step 314, CPU 102 determines the direction of touch operation (the direction of change of the touched position). By way of example, CPU 102 determines with which of four sides of window 250 the line connecting position coordinates stored in RAM 106 after repeated process of step 308 intersects. If the line intersects with the right side, left side, upper side or lower side of the window, the direction of touch operation is determined to be to the left, right, downward or upward, respectively.

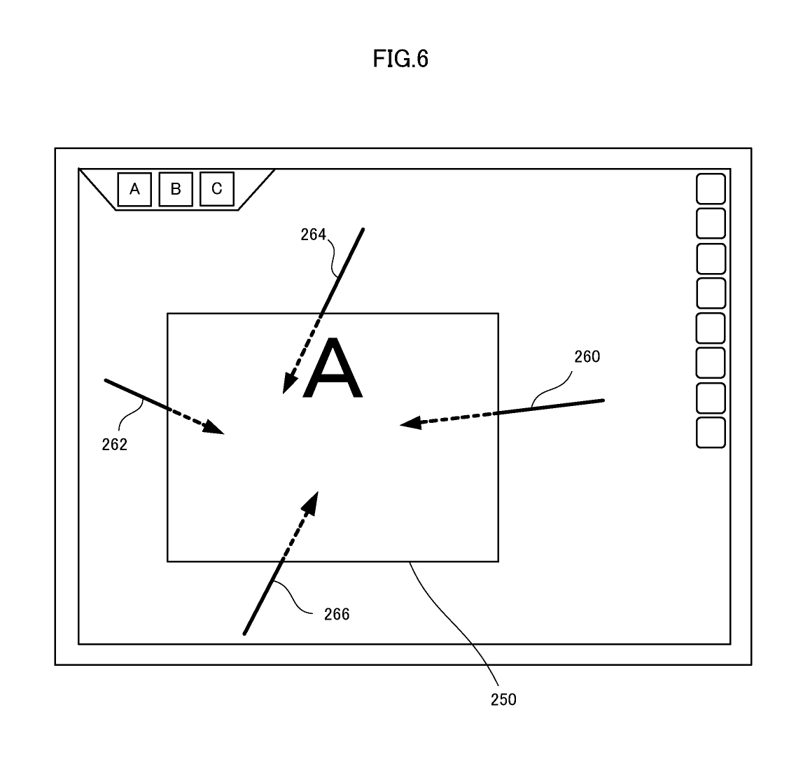

FIG. 6 shows, by arrows 260 to 266, various touch operations. The direction of each arrow represents the direction of touch operation. The solid line part of each arrow represents the initially touched position to the touch position immediately after entering the window 250, and the dotted line part represents the position where the touch position enters the window 250 to the position where the finger is left. From the coordinates of the touched position immediately after entering window 250 and the immediately preceding coordinates of a touched position outside window 250, it is possible to determine which side of window 150 is crossed by the trajectory of touching. Arrows 260 to 266 intersect the right, left, upper and lower sides of window 250, respectively.

At step 316, CPU 102 executes a file operation allocated in advance, in accordance with the direction of touch operation determined at step 314. By way of example, if the direction of touch operation is to the left, the next page image of the page image currently displayed on the window is displayed (hereinafter also referred to as “page forward operation”). If the direction of touch operation is to the right, the previous page of the page image currently displayed on the window is displayed (hereinafter also referred to as “page back operation”). If the direction of touch operation is downward, the file displayed as window 250 is closed (window 250 is erased from display screen 230). If the direction of touch operation is upward, an operation of printing the file displayed as window 250 is executed (for example, a print setting window is displayed).

At step 318, CPU 102 determines, as at step 308, whether the touch is maintained. Step 318 is repeated until it is determined that the finger is left from touch-detecting unit 112 and the touch is no longer maintained. If it is determined that the touch is no longer maintained, the control returns to step 300.

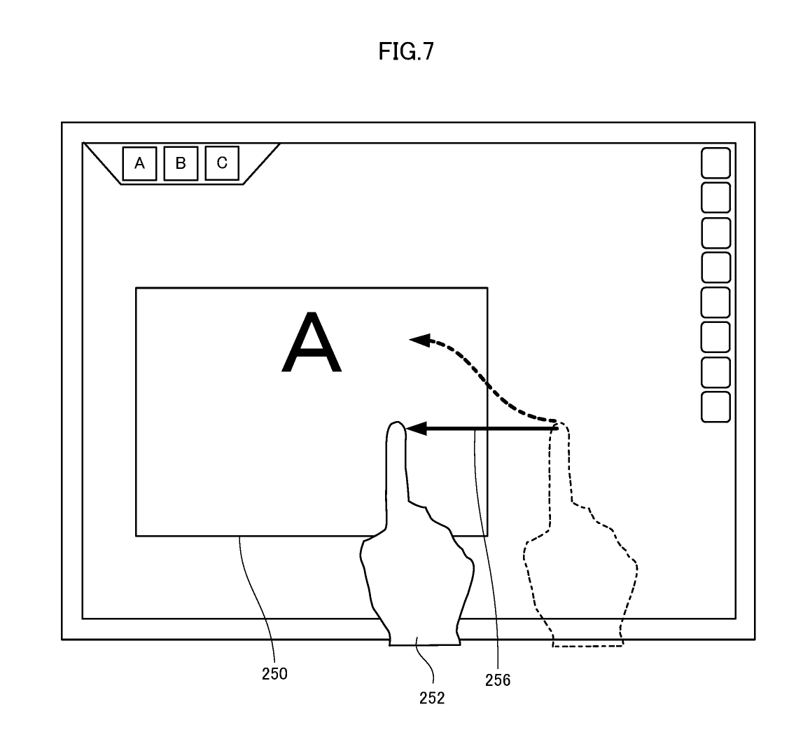

As described above, if the user first touches an area outside the window 250 and keeps touching and moves the touched position into the window 250, it is possible to realize the window operation in accordance with the direction of touch operation at that time in the drawing mode, without necessitating the mode switching operation. For example, as represented by a solid arrow 256 to the left in FIG. 7, when the user touches an area outside window 250 at first and then swipes to the left, the page forward operation is executed. At this time, as represented by a dotted arrow in FIG. 7, even if the trajectory of swipe operation is curved, page forward operation can be executed.

When the user wishes to draw, he/she can draw a desired character or figure in the window by touching inside the window first.

In this manner, it is possible for the user to realize the page forward operation, the page back operation and the like without any troublesome operation, and it is not necessary to be always aware of whether it is the drawing mode, or to confirm the operational mode before every operation. Thus, an easy and intuitive file operation environment for the user is provided.

Though an example in which different file operations are allocated to the four sides of the window has been described above, it is not limiting. Each side may be divided into a plurality of parts (segments), and different file operations may be allocated to respective segments. For example, the lower side of window may be divided into two parts (segments) at the center of the lower side, and if the trajectory of touched positions intersects the left side segment of the lower side, an operation of printing the file displayed in window 250 may be executed, and if the trajectory intersects the right side segment, an operation of printing the page image displayed in window 250 may be executed.

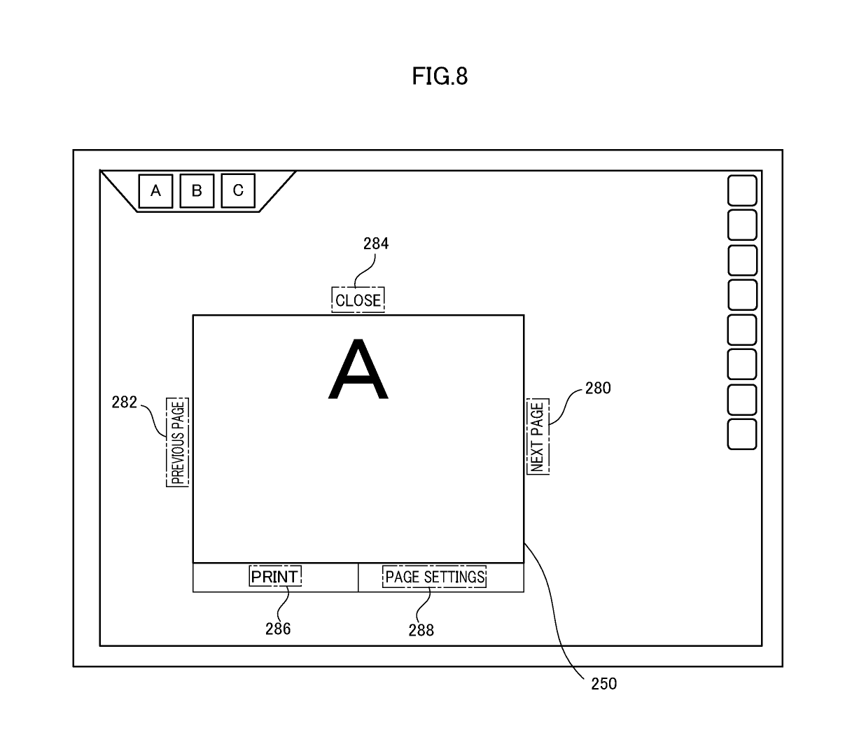

When different operations are allocated to the sides (or segments of sides) of the window with which the trajectory of touched positions intersects as described above, it is desirable to display operation descriptions for easier understanding of contents of operations. By way of example, corresponding operation descriptions 280 to 288 may be displayed close to respective sides, as shown in FIG. 8. Since the lower side is divided to two segments and different operations are allocated, a border line is displayed to distinguish the two operations. The border line, however, may not be displayed. The displayed operation description is not limited to texts, and icons or figures may be used. The operation description may include an arrow indicating the direction of touch operation. When the window is moved, the operation descriptions move accompanying the window, and when the window is erased (file close), the descriptions are also erased.

While the direction of touch operation is determined using the position coordinates immediately after the touched position enters the window in the example above, the method of determining the touch operation is not limited thereto. By way of example, if it is determined at step 312 that the touched position entered the window, the detection of touched position may be continued and when the touching is no longer maintained (when the finger is left from touch-detecting unit 112), the direction of touch operation may be determined using the last received position coordinates (the position coordinates of the point where the finger is left) and the position coordinates of the touch start point (position coordinates stored at step 302). Specifically, the direction of touch operation may be determined by a vector having the touch start position as the start point and the touch end position as the end point.

In the page forward operation described above, the number of pages fed by one operation may be changed in accordance with the speed of touch operation. By way of example, the number of pages fed at one time may be increased as the speed of touch operation is higher. In order to find the speed of touch operation, CPU 102 simply has to store the position coordinates received from touch-detecting unit 112 and the time of reception of position coordinates obtained from a timer, in association with each other in RAM 106. By way of example, using a plurality of coordinates of touched positions around the point of intersection between the trajectory of touched positions and the side of window and the corresponding time points, the speed of movement of touched position may be calculated, and the resulting speed of movement may be used as the speed of touch operation.

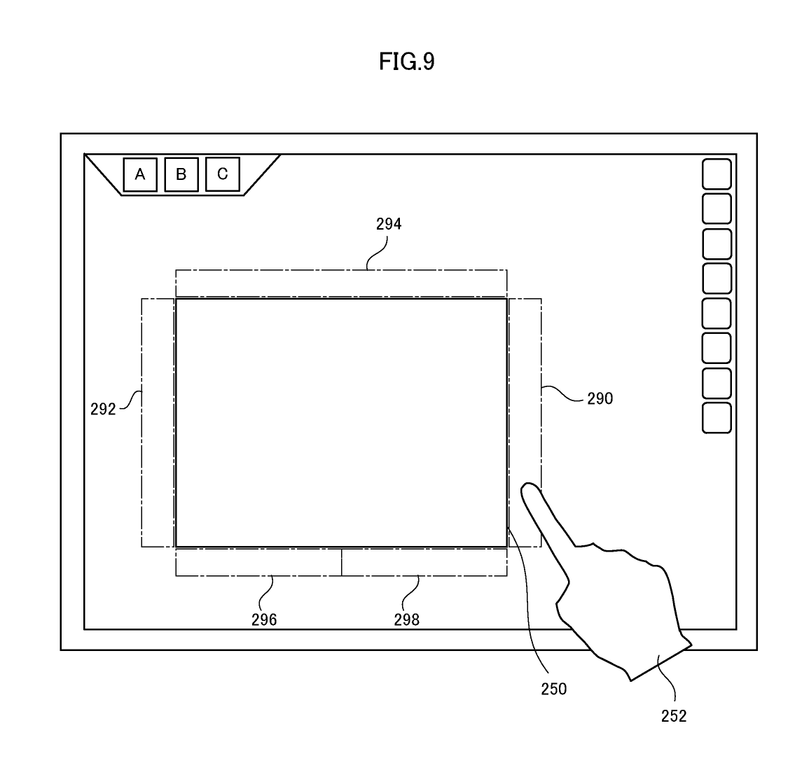

Though an example in which the file displayed on the window is operated in accordance with the trajectory of touch operation has been described above, it is not limiting. By way of example, a prescribed file operation may be executed in accordance with a touched position around (outside) the window. FIG. 9 shows areas 290 to 298 around window 250, to which prescribed operations are allocated. The lines representing the borders of areas 290 to 298 may or may not be displayed. If the operations are allocated in the similar manner as shown in FIG. 8, when areas 290 to 298 are touched, the page forward operation, page back operation, file close operation, file print operation and the operation of printing the displayed page image are executed, respectively.

According to the conventional user interface, any touch operation is interpreted as an operation of selecting an object (icon or the like) displayed at the touched position. By way of example, in multi-window display in which a plurality of windows are displayed at one time, when one window is being selected and the surrounding area (outside) of the window is touched, selection of the window that has been selected is cancelled. If another window exists at the touched position, this touched window is selected. According to the present operation, however, if a prescribed area around the selected window (for example, external area of a prescribed width along a side of the window) is touched, the file operation of the window is determined and executed while the selected state of the window is maintained. Even when another object is displayed at the touched position, the object is not selected.

Here, to the swipe or flick operation to the left/right directions in the prescribed area above or below the window, the page forward operation or page back operation may be allocated. For instance, if a swipe operation or flick operation to the left is conducted in an area 294 on the upper side (or an area combining areas 296 and 298 on the lower side) of window 250, the page forward operation may be executed, and if a swipe operation or flick operation to the right is conducted, the page back operation may be executed.

Image display apparatus 100 is not limited to a display apparatus having a large screen. The present invention is generally applicable to any display apparatus that allows drawing and image screen operations by touching, including a tablet type terminal and the like.

Though an example in which the file displayed in the window is operated by an operation of touch-detecting unit 112 has been described above, it is not limiting. By way of example, if image display apparatus 100 (with or without touch-detecting unit 112) includes a mouse for a computer and its interface, the operation of the file displayed on the window may be executed by a mouse operation. In that case, similar process may be realized using position coordinates of a mouse cursor displayed on display screen 230, in place of the position coordinates of the touched point.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A display apparatus, comprising:
a display unit displaying an image on a display area;
a touch detecting unit detecting a touch input of a user to the display area; and
a process executing portion executing a drawing mode for executing a drawing process to the image and an operational mode for executing an operational process to the image,
wherein
if a process to the image is executed based on a position on which the touch input has been detected and if a continuous touch input from an outside of the image to an inside of the image is detected, then the process executing portion executes the operational process without executing the drawing process to the image even in a condition that the drawing mode is executed.

2. The display apparatus according to claim 1, wherein the display unit displays the image in such a manner that a size of the image is smaller than a size of the display area.

3. The display apparatus according to claim 1, wherein the image contains a plurality of page images, and
the process executing portion executes a switching process of the page images when a direction of a change of a touch position detected by the touch detecting unit is a right/left direction.

4. The display apparatus according to claim 3, wherein the image contains information related to a display order of the page images, and
the process executing portion executes the switching process of the page images on the basis of the information related to the display order.

5. The display apparatus according to claim 1, wherein the process executing portion executes a process for printing the image being displayed on the display unit when a direction of a change of a touch position detected by the touch detecting unit is an upward/downward direction.

6. A method of operating an display apparatus, the method comprising the steps of:
displaying an image on a display area;
detecting a touch input of a user to the display area; and
executing a drawing mode for executing a drawing process to the image and an operational mode for executing an operational process to the image,
wherein
if a process to the image is executed based on a position on which the touch input has been detected and if a continuous touch input from an outside of the image to an inside of the image is detected, then the operational process is executed without executing the drawing process to the image even in a condition that the drawing mode.

7. A non-transitory computer readable recording medium recording a program for causing a computer having a display unit to execute:
a displaying step of displaying an image on a display area of the display unit;
a touch detecting step of detecting a touch input of a user to the display area; and
a process executing step of executing a drawing mode for executing a drawing process to the image and an operational mode for executing an operational process to the image,
wherein
if a process to the image is executed based on a position on which the touch input has been detected and if a continuous touch input from an outside of the image to an inside of the image is detected, then in the process executing step, the operational process is executed without executing the drawing process to the image even in a condition that the drawing mode.
